(19) United States
(12) Patent Application Publication
(10) Pub. No.: US 2025/0342568 A1
(43) Pub. Date: Nov. 6, 2025

(54) GLOBAL HUMAN AND CAMERA MOTION ESTIMATION WITH MOTION DIFFUSION MODEL

(71) Applicant: NVIDIA Corporation, Santa Clara, CA (US)

(72) Inventors: Jiefeng Li, Guangzhou (CN); Umar Iqbal, San Jose, CA (US); Ye Yuan, Santa Clara, CA (US); Davis Rempe, Redwood City, CA (US); Jan Kautz, Lexington, MA (US); Haotian Zhang, Santa Clara, CA (US); Xue Bin Peng, Coquitlam (CA); Pavlo Molchanov, Mountain View, CA (US)

(21) Appl. No.: 18/795,561

(22) Filed: Aug. 6, 2024

Related U.S. Application Data
(60) Provisional application No. 63/642,912, filed on May 6, 2024.

(51) Int. Cl. G06T 5/60; G06T 5/70; G06T 5/77; G06T 7/20

(52) U.S. Cl. CPC G06T 5/60; G06T 5/70; G06T 5/77; G06T 7/20; G06T 2207/10016; G06T 2207/20081; G06T 2207/20084; G06T 2207/30244

(57) ABSTRACT

Systems and methods are disclosed that perform global human and camera motion estimation using a motion diffusion model that is attached to a control branch. For instance, using a controlled motion denoiser that comprises the motion diffusion model and the control branch, global human motions and the corresponding camera motions from “in-the-wild” videos may be estimated. Initially, SLAM may be used to initialize the camera motion and a pose estimation model may be used to estimate the local human motion. Combining the two, embodiments of the present disclosure initialize the global human motion. Then, during optimization and using a COIN system that includes the controlled motion denoiser and/or using a COIN algorithm, embodiments of the present disclosure enforce the global human and camera motion to satisfy a two-dimensional (2D) projection on videos and the motion distribution from the motion diffusion model.

### CLAIM OF PRIORITY

This application claims the benefit of U.S. Provisional Application No. 63/642,912 (Attorney Docket No. 514774) titled “Global Human and Camera Motion Estimation with Motion Diffusion Model,” filed May 6, 2024, the entire contents of which is incorporated herein by reference.

### BACKGROUND

Recovering global human and camera motion from dynamic red green blue (RGB) videos is an important problem with many applications, such as, but not limited to, animation, human-computer interaction, mixed reality, and robotics. Earlier conventional techniques focused only on human motion and ignored the camera motion. Thus, conventional approaches use local body movements to estimate the global orientation and trajectory with a regression model or by combining them with physical constraints. However, regression models ignore the camera movements so the regression models may fail to maintain consistency with the input video, while physics-based methods fail to model complex in-the wild environments so are limited to controlled scenarios.

Recent conventional techniques try to jointly estimate the human and camera motion by exploiting learned motion priors and simultaneous localization and mapping (SLAM). For instance, conventional techniques may try to constrain the human body motion in a low-dimensional latent space of a motion prior model, which results in reconstructed motions that are overly smooth and do not align well with video observation. Moreover, the optimization of the camera motion is only based on the global human motion from the motion prior, and hence the conventional techniques fail catastrophically if the initial human motion predictions are significantly incorrect. As such, there is a need for addressing the above issues and/or other issues associated with the prior art.

### SUMMARY

Embodiments of the present disclosure describe a hybrid Control-Inpainting (COIN) score distillation sampling (SDS) algorithm to address the limitations of traditional algorithms. For instance, an input video may include a person in motion (e.g., riding a skateboard) and while the local body motion may remain relatively constant, the global position of the individual changes significantly. Conventional methods (e.g., Person and Camera Estimation (PACE) and/or World-grounded Humans with Accurate Motion (WHAM)) may fail catastrophically on such out-of-distribution motions. For example, WHAM may be able to estimate global human motions, but is unable to recover the camera motions. On the other hand, PACE relies on human motion priors to regularize the camera motion, which may lead to inaccurate camera motion when the human motion is not well initialized.

In contrast to conventional approaches, such as those described above, embodiments of the present disclosure describe systems and methods related to global human and camera motion estimation using a motion diffusion model that is attached to a control branch. For instance, using a controlled motion denoiser that comprises the motion diffusion model and the control branch, global human motions and the corresponding camera motions from “in-the-wild” videos may be estimated. To put it another way, embodiments of the present disclosure may follow an optimization paradigm to recover the global human and camera motions. Initially, SLAM may be used to initialize the camera motion and a pose estimation model may be used to estimate the local human motion. Combining the two, embodiments of the present disclosure initialize the global human motion. Then, during optimization and using a COIN system that includes the controlled motion denoiser and/or using a COIN algorithm, embodiments of the present disclosure enforce the global human and camera motion to satisfy a two-dimensional (2D) projection on videos and the motion distribution from the motion diffusion model.

In other words, embodiments of the present disclosure (e.g., the COIN-SDS algorithm) describe a control-inpainting motion diffusion prior that enables fine-grained control to disentangle human and camera motions. For instance, embodiments of the present disclosure utilize control-inpainting score distillation sampling to ensure well-aligned, consistent, and high-quality motion from the diffusion prior within a joint optimization framework. Additionally, and/or alternatively, one or more embodiments of the present disclosure may use a new human-scene relation loss to alleviate the scale ambiguity by enforcing consistency among the humans, camera, and/or scene.

In some instances, embodiments of the present disclosure apply an SDS loss to distill the knowledge from the model diffusion model. Additionally, and/or alternatively, a ControlNet-based motion diffusion model may be built to generate more stable and reliable motion knowledge. Additionally, and/or alternatively, embodiments of the present disclosure develop a hybrid control-overwrite algorithm to enforce the consistency between the distilled knowledge and the observed motion information.

In an embodiment, a computer-implemented method includes determining an initial articulated object motion of an articulated object based on an input video comprising a plurality of frames that depict motion of the articulated object. The input video is obtained by a non-stationary camera and the initial articulated object motion is in a local coordinate system associated with the non-stationary camera. The method further includes determining, based on the input video, the initial camera motion in a global coordinate system that is a real-world coordinate system. The method also includes generating a plurality of intermediate denoised motions based on inputting a plurality of control signals and a plurality of latent motions associated with the initial articulated object motion into a controlled motion denoiser comprising a control branch and a motion diffusion model. The plurality of control signals are input into the control branch to control the motion diffusion model and the plurality of latent motions are input into the motion diffusion model to generate the plurality of intermediate denoised motions. The method further includes determining the global camera motion and the global articulated object motion based on the plurality of intermediate denoised motions and outputting the global camera motion and the global articulated object motion. The global camera motion and the global articulated object motion are both in the global coordinate system.

### BRIEF DESCRIPTION OF DRAWINGS

The present systems and methods for global human and camera motion estimation with motion diffusion model are described in detail below with reference to the attached drawing figures, wherein:

FIG. 1A illustrates a block diagram of a general overview of a system comprising a control-inpainting motion diffusion (COIN) system suitable for use in implementing one or more embodiments of the present disclosure.

FIG. 1B illustrates a process for updating camera and articulated object motion utilizing the COIN system, in accordance with one or more embodiments of the present disclosure.

FIG. 2A illustrates an overall framework for executing the COIN algorithm using the COIN system, in accordance with one or more embodiments of the present disclosure.

FIG. 2B shows a summary of the COIN algorithm, in accordance with one or more embodiments of the present disclosure.

FIG. 3 illustrates a flowchart of a method for using the COIN algorithm and the COIN system, in accordance with an embodiment.

FIG. 4 illustrates an example parallel processing unit suitable for use in implementing some embodiments of the present disclosure.

FIG. 5A is a conceptual diagram of a processing system implemented using the PPU of FIG. 4, suitable for use in implementing some embodiments of the present disclosure.

FIG. 5B illustrates an exemplary system in which the various architecture and/or functionality of the various previous embodiments may be implemented.

FIG. 5C illustrates components of an exemplary system that can be used to train and utilize machine learning, in at least one embodiment.

FIG. 6 illustrates an exemplary streaming system suitable for use in implementing some embodiments of the present disclosure.

### DETAILED DESCRIPTION

Recently, denoising diffusion models have emerged as a powerful family of generative models that may model high-quality data priors, but effectively leveraging the learned priors remain an ongoing challenge. SDS may be commonly employed for such a purpose; however, for recovering global human and camera motion, SDS also results in inconsistencies with the available observations. The root cause of this problem lies in the inconsistency of randomly sampled motions during SDS optimization. Without constraints, the randomly sampled motions might not align with observed evidence, leading to overly smoothed results that lack detail due to the mode-averaging effect.

To address the aforementioned limitations of naive SDS, embodiments of the present disclosure utilize a COIN system and/or a COIN-SDS algorithm. For instance, the COIN system may use partially observed evidence from the video as a control signal to guide motion sampling. Since the observed evidence may be noisy and/or occluded, the COIN system may include a controlled motion denoiser to handle noisy observations. Additionally, and/or alternatively, to further improve the consistency of the sampled motions, the COIN system utilizes a soft inpainting strategy. For instance, the COIN system may automatically identify the high-confidence regions of the initial predicted global motion from the video and use them as soft constraints during optimization. In some variations, the COIN system may sample less confident regions from scratch using the motion diffusion model, while the confident regions may be slightly refined. This may ensure that the reconstructed motions do not deviate from the available observations. Further, the COIN system may use a new SDS formulation (e.g., COIN-SDS) to jointly optimize human and camera motion by finding the most plausible solution that explains the observed evidence. Additionally, and/or alternatively, to prevent catastrophic failure in instances where the initial body or camera motion from SLAM fails significantly, the COIN system may further use a human-scene relation loss to consider the human-scene depth relations. The human-scene relation loss may provide complementary information to the human motion prior by using local motion and scene features. For instance, the human-scene relation loss may regularize the camera scale by enforcing consistency among the human motion, camera motion, and/or scene features.

As will be described in more detail below, embodiments of the present disclosure describe a control-inpainting motion prior that is specifically designed for global human motion estimation, which enhances SDS with dynamic control and soft inpainting to reconstruct well-aligned, consistent, and high-quality motions from video observations. Additionally, and/or alternatively, embodiments of the present disclosure may use a new human-scene relation loss to resolve the scale ambiguity of the camera motion by enforcing consistency among the human motion, camera motion, and scene features. It was demonstrated that embodiments of the present disclosure significantly outperform the current state-of-the-art methods in terms of human motion estimation and camera motion estimation. For instance, in terms of global human motion estimation in the world space, embodiments of the present disclosure outperformed PACE by 44% and 33% on several datasets of data and outperform WHAM by 49% and 7% on the same datasets of data.

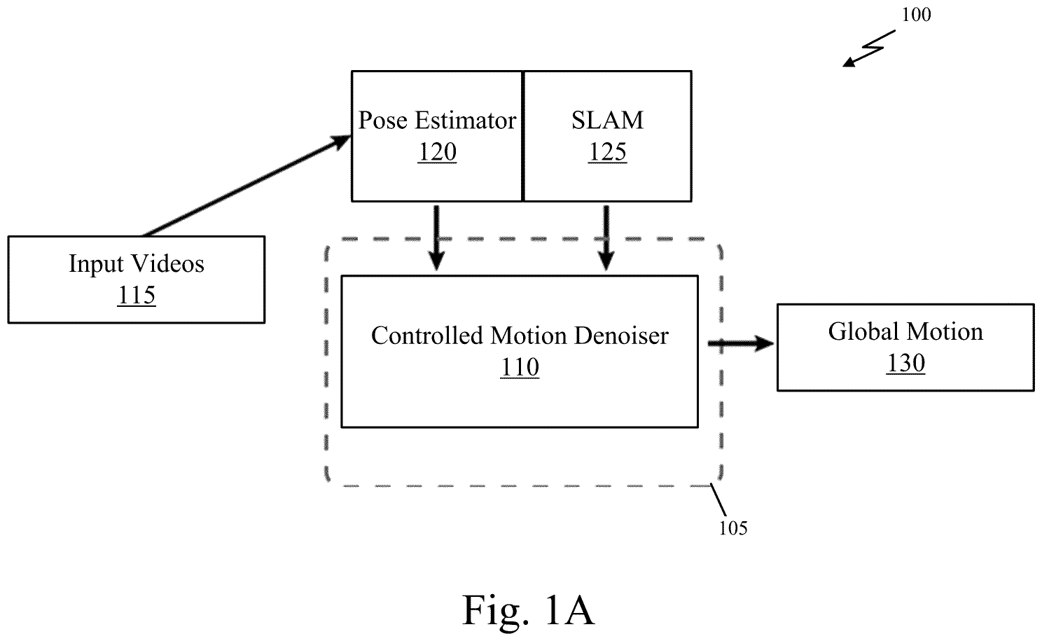

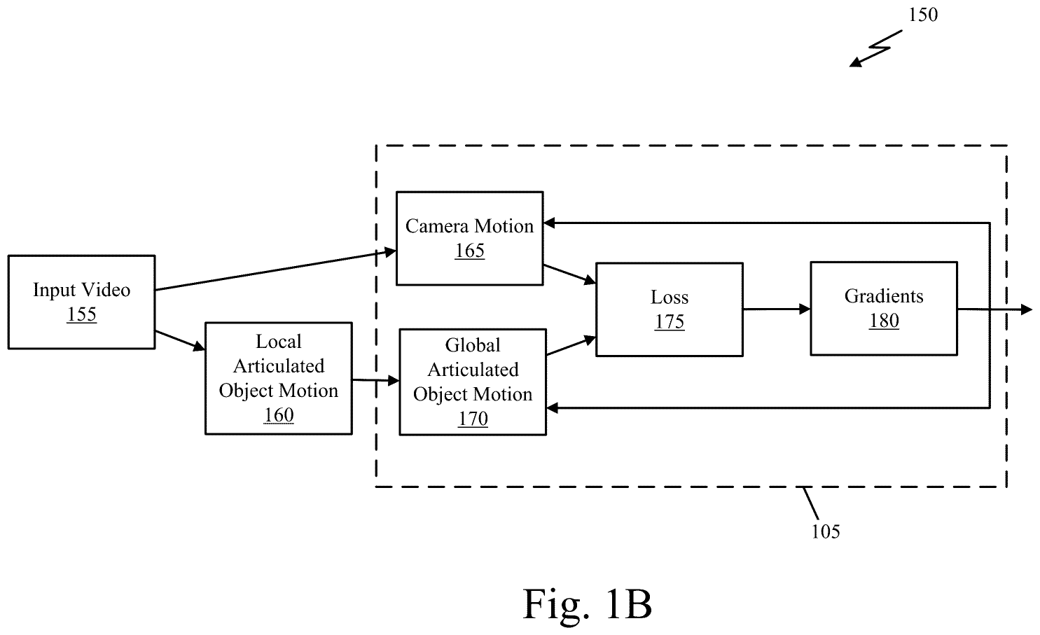

FIG. 1A illustrates a block diagram of a general overview of a system 100 comprising a control-inpainting motion diffusion (COIN) system 105 suitable for use in implementing one or more embodiments of the present disclosure. The system 100 includes input videos 115, a pose estimator 120 (e.g., a two-dimensional (2D) or a three-dimensional (3D) pose estimator), a simultaneous localization and mapping (SLAM) 125, the COIN system 105 comprising a controlled motion denoiser 110, and global motion 130. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the system 100 and/or the COIN system 105 is within the scope and spirit of embodiments of the present disclosure.

For example, the system 100 receives input videos 115 that are obtained while the camera and an object of interest (e.g., an articulated object such as a human) is in motion. Utilizing the controlled motion denoiser 110, the system 100 accurately estimates the global motion 130 (e.g., the global articulated object and camera motion in a global world coordinate system). The global world coordinate system may be a real-world coordinate system where the motion takes place. For instance, from the input videos 115, SLAM (e.g., Deep Visual Simultaneous Localization and Mapping (DROID SLAM)) 125 may be used to obtain the initial camera motion, which may be in the global world coordinate system. Further, the Pose Estimator 120 (e.g., a 3-dimensional (3-D) Pose Estimator) may be used to obtain the initial articulated object motion, which is in a local coordinate system (e.g., a coordinate system associated with the camera). Using an additional algorithm, the initial articulated object motion (e.g., local articulated object motion) may be converted into the global world coordinate system (e.g., initial global articulated object motion). For instance, the conversion from the initial articulated object motion to the initial global articulated object motion may be performed in two parts: 1) a global human orientation; and 2) a global human translation. For the global human orientation, the system 100 may obtain this by multiplying the local human orientation with the camera orientation. For the global human translation, the system 100 may obtain this by multiplying the local human translation with the camera orientation, and adding the result to the camera position. However, the extracted initial global articulated object motion and camera motion are often inaccurate. The system 100 may then use the controlled motion denoiser 110 to determine more accurate global camera and global articulated object motion. This is described in more detail in FIG. 1B.

FIG. 1B illustrates a process 150 for updating camera and articulated object motion utilizing the COIN system 105, in accordance with one or more embodiments of the present disclosure. For instance, after receiving an input video 155, the process 150 may utilize the 2D pose estimator 120 and/or SLAM 125 to determine the camera motion 165 and the global articulated object motion 170. For example, using SLAM 125, the camera motion 165 may be obtained, which may be represented by the camera pose at each frame of the input video 155 (e.g., a camera pose comprising a rotation matrix and translation vector). Using the Pose Estimator 120, the local articulated object motion 160 may be obtained. Subsequently, using an additional algorithm (e.g., multiplying the local human orientation and/or the local human translation with the camera orientation), the global articulated object motion 170 may be obtained from the local articulated object motion 160.

For example, in an embodiment, the input video 155 may be an “in-the-wild” input video (e.g., an input video that is from the Internet or another source) and may show an articulated object (e.g., human) in motion. Further, while the articulated object is moving within the video, the camera that is being used to capture the video is also moving. The articulated object motion may be described using two sets of coordinate planes—a global coordinate plane and a local coordinate plane. The local coordinate plane may be associated with the camera (e.g., defined by the camera) that is capturing the input video 155. For instance, the origin of the local coordinate plane may be situated at the location of the camera and if the camera does not move within the input video 155, the local coordinate plane may be used to capture the motion of the articulated object. However, if the camera is also in motion, the local coordinate plane might not be able to adequately capture the motion of the articulated object as the origin of the local coordinate plane (e.g., the location of the camera) will also move when the camera is moving. Therefore, given that the camera is also in motion, the change of the articulated object in the local coordinate plane might not translate completely to the global coordinate plane. As such, embodiments of the present disclosure uses SLAM 125, the Pose Estimator 120, and an additional algorithm to estimate the initial camera motion 165 and the initial global articulated object motion 170 in the global coordinate plane. However, using the above three algorithms might not provide an accurate representation of the camera motion 165 and the global articulated object motion 170 in the global coordinate plane. Thus, embodiments of the present disclosure may further use the COIN system 105 to refine and determine more accurate estimations of the camera motion 165 and the global articulated object motion 170.

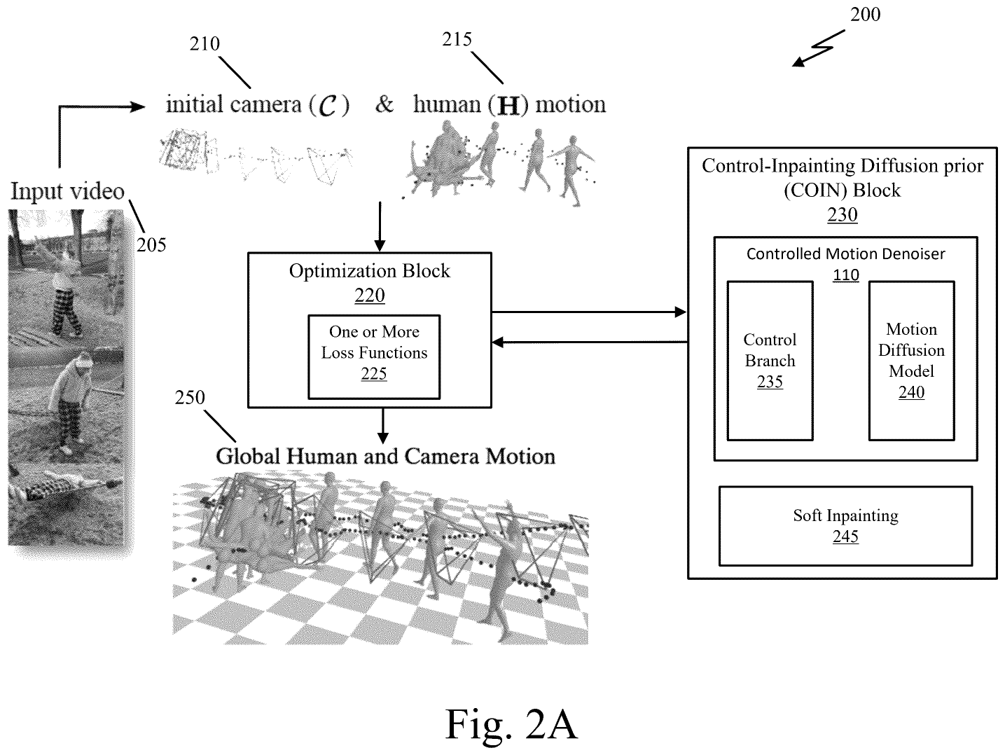

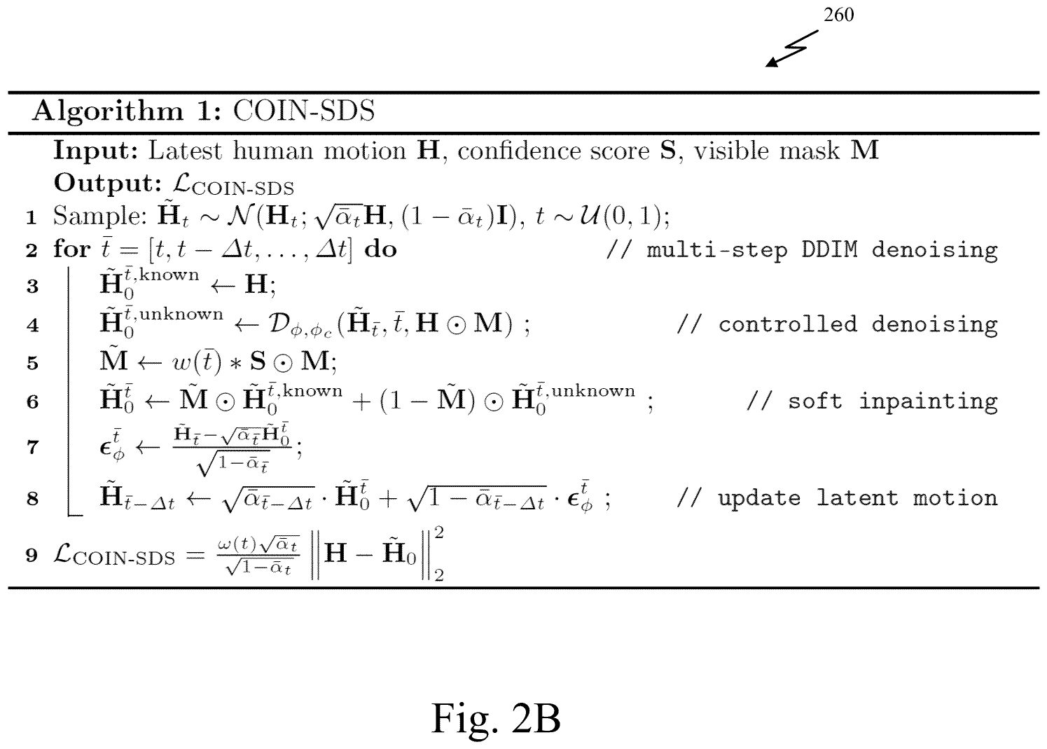

For example, based on the input video 155 and the local articulated object motion 160, the COIN system 105 receives the initial camera motion 155 and the global articulated object motion 170, which may refer to the estimation of camera and articulated object motion that is computed prior to performing any optimization (e.g., refinement) of such estimations. After obtaining the initial motions, the COIN system 105 executes a COIN algorithm, which is described in FIG. 2A and summarized in FIG. 2B below, to perform global optimization to refine the global articulated object motion 170 and the camera motion 165 and recover an accurate global trajectory of the camera motion 165 and the articulated object motion 170. For instance, using the COIN algorithm, the COIN system 105 samples motions from the camera motion 165 and/or the global articulated object motion 170, and based on the sampling, the COIN system 105 computes the losses 175. In some embodiments, the losses 175 may include a Control-Inpainting Score Distillation Sampling (COIN-SDS) loss that is determined using the controlled motion denoiser 110. Using the losses 175, the COIN system 105 further determines the gradients 180 and then updates the camera motion 165 and the global articulated object motion 170 based on the gradients 180. For instance, the COIN system 105 may perform back-propagation, and obtain the gradients 180 of the motion based on the losses 175. Then, the COIN system 105 may update the camera motion 165 and the global articulated object motion 170 using the gradients 180 and A Method for Stochastic Optimization (ADAM), which is an algorithm for a first-order gradient-based optimizer.

Subsequently, the COIN system 105 performs another iteration of this process (e.g., sampling, determining losses 175 and gradients 180, and updating the motions 165 and 170) to continuously determine more accurate camera motion 165 and global articulated object motion 170 until a threshold is reached. For example, in some embodiments, the threshold may be associated with a number of iterations that has been performed by the COIN system 105. For instance, the COIN system 105 may use a counter to indicate a number of iterations that it has performed of the process 150, and compare the counter with the threshold (e.g., 500 iterations). Once the counter reaches the threshold, the COIN system 105 may determine the training has been completed. After the threshold is reached, the COIN system 105 outputs the accurate global trajectory of the camera motion 165 and the articulated object motion 170. The COIN system 105 and determining the losses 175 is described in further detail in FIG. 2A.

In other words, prior to describing the framework of the COIN system 105 and referring to FIGS. 1A and 1B, given an in-the-wild RGB video with T frames captured by a dynamic camera, a goal of the COIN system 105 is to estimate both the global articulated object motion (e.g., H={h⁽¹⁾, h⁽²⁾, . . . , h^{(T)}} where H is the overall estimated global articulated object motion and h is the estimated global articulated object motion at each frame of the input video) and the camera motion (e.g., C={c⁽¹⁾, c⁽²⁾, . . . , c^{(T)}} where C is the overall estimated camera motion and c is the estimated camera motion at each frame of the input video) in a global world coordinate system. As such, in some embodiments, after performing multiple iterations (e.g., 500 iterations described above), the COIN system 105 may output the camera motion 165 and the global articulated object motion 170 from the latest iteration, and this final output may indicate an estimated overall global articulated object motion H and estimated camera motion C.

In some embodiments, off-the-shelf 3D human pose and shape estimation methods (e.g., HybriIK that is described by Li et al. In “Hybrik: A hybrid analytical-neural inverse kinematics solution for 3d human pose and shape estimation” CVPR, 2021, the entire contents of which is incorporated herein by reference) may be used to obtain per-frame initial Skinned Multi-Person Linear model (SMPL) parameters in the camera space (e.g., the initial camera motion 165 from the input video 155) and a SLAM algorithm (e.g., DROID-SLAM that is described by Teed et al. In “DROID-SLAM: Deep Visual SLAM for Monocular, Stereo, and RGB-D Cameras” NeurIPs, 2021, the entire contents of which is incorporated herein by reference) may be used obtain the initial per-frame camera-to-world transforms (e.g., the local articulated object motion 160 from the input video 155). Further, the local human motion is converted to the world coordinates with the estimated camera (e.g., using an additional algorithm, the local articulated object motion 160 is converted to the global articulated object motion 170). However, because the camera trajectories from SLAM are up to an unknown scale, the initial global human motion (e.g., the global articulated object motion 170) may abnormally drift and float in the world space. To resolve the ambiguity and place the person in the correct global position, the COIN system 105 may jointly optimize the human and camera motion to minimize the discrepancy between the observed evidence and the estimated motion, while maintaining the plausibility of the human motion with a diffusion prior through using control-painting SDS.

The camera motion may be represented by the trajectory

$$C = {\{ ( {R}^{( i )} , {t}^{( i )} ) \}}_{i = 1}^{T}$$

where [R⁽ⁱ⁾, t⁽ⁱ⁾] is the camera pose at the i-th frame, comprising the rotation matrix R⁽ⁱ⁾∈ [symbol] ^{3×3} and the translation vector t⁽ⁱ⁾∈ [symbol] ³. The human motion (e.g., articulated object motion) may be represented by the human trajectory

$$H = {\{ {h}^{( i )} \}}_{i = 1}^{T} ,$$

Where h⁽ⁱ⁾=[τ⁽ⁱ⁾, ϕ⁽ⁱ⁾, f⁽ⁱ⁾, β] is the human pose at the i-th frame that comprises the global translation τ⁽ⁱ⁾∈ [symbol] ³, the global orientation q⁽ⁱ⁾∈ [symbol] ³, the body pose parameters θ⁽ⁱ⁾∈ [symbol] ^{23×3}, the foot contact labels f∈{0,1}⁴, and the body shape parameters β∈ [symbol] ¹⁰. The human pose and shape may be represented by the SMPL model. The body meshes

$${\{ V \}}_{i = 1}^{T}$$

may be obtained from the linear function [symbol] (ϕ, τ, θ, β) and the articulated body joints may be calculated by a linear combination of the mesh vertices through a linear regressor.

Before describing the framework of the COIN system 105 in more detail, the formulation and drawbacks of SDS are revisited. SDS was first introduced to distill 3D assets from pre-trained 2D text-to-image diffusion models. SDS exploits the knowledge from the diffusion models by seeking modes for the conditional distribution in the Denoising Diffusion Probabilistic Models (DDPM) latent space to optimize the 3D scene representation. Similarly, the global human motion may be optimized by distilling knowledge from a pre-trained motion diffusion model.

For instance, given a global human motion H, the marginal distribution of noisy latent Hₜ at time step t∈U(0,1) may be defined as:

$$q ( {H}_{t} \vert H ) = N ( {H}_{t} ; \sqrt{{\overline{a}}_{t}} H , ( 1 - {\overline{α}}_{t} ) I \qquad Eq . 1$$

where α̅t∈(0,1) is a hyper-parameter controlled by the variance schedule of the diffusion model, N is a normal distribution, and I is the variance. SDS adopts the pre-trained diffusion model D_{ϕ}(Hₜ, t, y), which takes in Hₜ and is used to model the conditional density of the human motion, where ϕ are the parameters of the diffusion model and y is the condition. Then, SDS aims to distill global human motion H via seeking modes of the learned condition density, which may be achieved by a weighted denoising score matching objective

$$( e . g . , {min}_{H} {L}_{SDS} )$$

$${min}_{H} {L}_{SDS} := {𝔼}_{t , ϵ} [ ω ( t ) {‖ {ϵ}_{ϕ}^{t} - ϵ ‖}_{2}^{2} ] \qquad Eq . 2$$

where

$${ϵ}_{ϕ}^{t}$$

is the predicted denoising direction from the diffusion model, Hₜ˜q(Hₜ|H) is sampled using the reparameterization trick, ϵ is the corresponding sampled noise, and ω(t) is a weighting function that depends on the time step t.

To review the effect of SDS, Eq. 2 may be reparameterized as:

$${min}_{H} {L}_{SDS} := {𝔼}_{t} [ \frac{ω ( t ) \sqrt{{\overline{α}}_{t}}}{\sqrt{1 - {\overline{α}}_{t}}} {‖ H - {\hat{H}}_{0}^{t} ‖}_{2}^{2} ] \qquad Eq . 3$$

$$where$$

$${\hat{H}}_{0}^{t} = \frac{{H}_{t} - \sqrt{1 - {\overline{α}}_{t}} {ϵ}_{ϕ}^{t}}{\sqrt{{\overline{α}}_{t}}} \qquad Eq . 4$$

Based on this reparameterization, it can be seen that the SDS objective is to minimize the discrepancy between the global human motion H and the denoised global human motion

$${\hat{H}}_{0}^{t}$$

from the motion diffusion model in a single step. The denoised motion

$${\hat{H}}_{0}^{t}$$

may serve as the pseudo ground truth. However, at each optimization step, t and ϵ may be randomly sampled to generate the noisy latent Hₜ, and it was found that the pre-trained diffusion model is sensitive to the input. Minor fluctuations in the input latent may substantially change the denoised motion, which leads to inconsistency in

$${\hat{H}}_{0}^{t}$$

across different time steps.

Although randomness may help generate diverse plausible motions to infer occluded regions and unknown information, it might not be needed for well-observed regions, such as simple body poses in a clean background. Such randomness in the denoising steps makes the generated

$${\hat{H}}_{0}^{t}$$

difficult to align with the local 2D observations and results in wrong global human motion. Moreover, this pseudo ground truth

$${\hat{H}}_{0}^{t}$$

is generated from only a single denoising step, where the diffusion models might not produce high-quality motions, resulting in foot sliding and floating. Although sampling with a smaller time step t may alleviate the issues, the initial motion is usually inaccurate and the denoiser is not able to remove artifacts with a small t. To exploit the knowledge of the motion diffusion model and denoise the initial motion, the SDS may be allowed to sample with a larger time step t while maintaining high quality, consistency, and alignment with the local 2D observations.

Limitations of SDS described above may originate from the randomness and inconsistency of the denoised motion

$${\hat{H}}_{0}^{t} ,$$

which serves as a pseudo ground truth in the objective function. To overcome this issue, the COIN system 105 generates high-quality and consistent pseudo-ground-truth motions. For instance, as will be described below, the COIN system 105 may utilize one or more of the below. First, to achieve high-quality motions, the COIN system 105 may produce the pseudo ground truth with multiple DDIM denoising steps. Second, to encourage consistent motions, the COIN system 105 may use partially observed evidence from the video as a control signal to dynamically guide the diffusion model and align the generated motions with the observations. Third, to further align the motion with observed regions, the COIN system 105 may use a soft inpainting strategy within the denoising process. Each of the three aspects is described in further detail in FIG. 2A.

In some instances, one or more of the aspects may be absent from one or more embodiments of the present disclosure. For example, embodiments of the present disclosure may utilize the second aspect described above (e.g., the control branch attached to the motion diffusion model), but might not include and/or utilize the first and third aspects (e.g., the multiple DDIM denoising steps and/or the soft inpainting strategy). In other instances, embodiments of the present disclosure may utilize all three aspects.

FIG. 2A illustrates an overall framework 200 for executing the COIN algorithm using the COIN system 105, in accordance with one or more embodiments of the present disclosure. For instance, the framework 200 includes an input video 205 (e.g., input video 155) that is converted into the initial camera motion 210 (e.g., camera motion 165) and human motion 215 (e.g., global articulated object motion 170). The framework 200 further includes the optimization block 220 that includes one or more loss functions 225 and the COIN block 230 that includes the controlled motion denoiser 110 and soft inpainting 245. The controlled motion denoiser 110 includes a control branch 235 and a motion diffusion model 240. The optimization block 220 and the COIN block 230 may be used to determine the losses 175 and the gradients 180 from FIG. 1B, and then update (e.g., refine) the camera motion 165 and the global articulated object motion 170. After updating the camera motion 165 and the global articulated object motion 170, the process may repeat for one or more iterations (e.g., 500 iterations as described above). Subsequently, the global human and camera motion 250 (e.g., the updated the camera motion 165 and the global articulated object motion 170 after performing the process a set number of iterations) may be output.

For example, the COIN algorithm includes the optimization block 220 and the COIN block 230, which are used to refine the initial estimations to obtain an accurate global trajectory of the camera and articulated object motions. For instance, during the optimization stage or inference stage, the inputs to the optimization block 220 include the initial camera motion 210 and the initial global human motion 215. Then, the optimization block 220 provides the initial motions to the COIN block 230. The COIN block 230 performs the three aspects described above (e.g., the multiple DDIM denoising steps, using the partially observed evidence from the video as a control signal to dynamically guide the diffusion model and align the generated motions with the observations, and using a soft inpainting strategy within the denoising process).

The second aspect (e.g., using a control signal to dynamically guide the diffusion model or dynamic controlled sampling) is first described. Specifically, at the beginning, the latest articulated object motion (H) is the initial global articulated object motion, and is provided as both a control signal to a control branch 235 of the controlled motion denoiser 110 as well as combined with a noise signal to generate a noisy latent distribution Hₜ. The noisy latent distribution Hₜ is sampled to obtain the latent motion (\tilde{H}ₜ), which is then input into the motion diffusion model 240.

Based on providing the control signal (e.g., the initial global articulated object motion 215) to the control branch 235 and the latent motion (e.g., the sampling from the noisy latent) to the motion diffusion model 240, the controlled motion denoiser 110 generates intermediate denoised motion

$$( {\tilde{H}}_{0}^{t , unknown} ) .$$

For instance, the controlled motion denoiser 110 may include a motion diffusion model 240 that has multiple transformer encoder layers and that is controlled by the control branch 235. Using the control signal, the control branch 235 guides the motion generation of the motion diffusion model 240, contributing to optimization of the global human motion by providing a control signal that better aligns with the input videos.

In an embodiment, prior to using the controlled motion denoiser 110 during the optimization/inference phase, the controlled motion denoiser 110 may be trained. For example, initially, a system (e.g., the COIN system 105 and/or another system that provides the trained controlled motion denoiser 110 to the COIN system 105) may train the motion diffusion model 240, and then freeze the parameters of the motion diffusion model 240. Subsequently, the system may train the control branch 235 using the trained motion diffusion model 240. After training, the COIN system 105 may use the trained controlled motion denoiser 110 as described above to estimate the refined global articulate object and camera motions.

In some embodiments, after using the controlled motion denoiser 110 to generate the intermediate denoised motion

$$( {\tilde{H}}_{0}^{t , unknown} ) ,$$

the intermediate denoised motion is provided to the soft inpainting 245 to perform inpainting. In other words, in some examples, embodiments of the present disclosure may include soft inpainting block 245 (e.g., aspect three above) and utilize soft inpainting along with the dynamic controlled sampling. For instance, the soft inpainting 245 uses the intermediate denoised motion and known articulated object motion

$$( {\tilde{H}}_{0}^{t , known} )$$

to generate the inpainted motion

$$( {\tilde{H}}_{0}^{t} ) .$$

Initially, during the first iteration, the known articulated object motion may be the initial motion that is converted from the local human motion and the camera motion. Then, in subsequent iterations, the known articulated object motion may be the latest articulated object motion (H). Thus, using the below equation, the inpainted motion is generated:

$${\tilde{H}}_{0}^{t} = \tilde{M} ⊙ {\tilde{H}}_{0}^{t , known} + ( 1 - \tilde{M} ) ⊙ {\tilde{H}}_{0}^{t , unknown} \qquad Eq . 5$$

where the inpainted motion is

$${\tilde{H}}_{0}^{t} ,$$

⊙ is an element-wise multiplication, \tilde{M} is the continuous mask,

$${\tilde{H}}_{0}^{t , known}$$

are known regions (e.g., the optimized human motion from the previous iteration H), and

$${\tilde{H}}_{0}^{t , unknown}$$

are the unknown regions (e.g., the output from the controller denoiser). The continuous mask \tilde{M} is determined based on a weight that linearly decreases as the denoising time step decreases, the confidence score S, and the visible mask M. The confidence score S may be obtained from the pose estimator 120 from FIG. 1A. For instance, the pose estimator 120 may predict both the local human motion as well as one or more confidence scores. Each confidence score may be associated with a body part (e.g., body joint), and if the confidence score is greater than a threshold (e.g., greater than 0.3), then this body part may be considered “visible.” The visible mask M may be associated with the body parts that are considered “visible” (e.g., the body parts that have confidence scores from the pose estimator 120 that are greater than the threshold).

In some variations, in addition to using both the soft inpainting 245 and the dynamic controlled sampling, embodiments of the present disclosure may further perform multiple denoising steps (e.g., the first aspect described above). For instance, instead of the first generated inpainted motion

$${\tilde{H}}_{0}^{t}$$

being provided back to the optimization block 220 and used to determine the losses, the COIN algorithm uses the first generated inpainted motion (e.g.,

$${\tilde{H}}_{0}^{t}$$

from Eq. 5) to determine a predicted denoising direction, and uses the predicted denoising direction to update the latent motion. The process then repeats and a new generated inpainted motion is generated. For instance, while

$${\tilde{H}}_{0}^{t , known}$$

and the control signal may be the same as the previous iteration, the controlled motion denoiser 110 is provided with an updated latent motion from the previous iteration, which causes the generated intermediate denoised motion to be different for each iteration (e.g., closer to the pseudo ground truth). In other words, as mentioned previously and in the first denoising step, the latest articulated object motion (H) is the initial global articulated object motion, and is provided as both a control signal to a control branch 235 of the controlled motion denoiser 110 as well as combined with a noise signal to generate a noisy latent distribution Hₜ. The noisy latent distribution Hₜ is sampled to obtain the latent motion (\tilde{H}ₜ), which is then input into the motion diffusion model 240. In the second denoising step, the control signal that is provided to the control branch 235 may still be the same (e.g., the articulated object motion (H)). However, the first generated inpainted motion (e.g.,

$${\tilde{H}}_{0}^{t}$$

from Eq. 5) may be combined with a noise signal to generate a noisy latent distribution, and the noisy latent distribution may be sampled and provided as input to the motion diffusion model 240. The COIN system 105 may utilize the output from the motion diffusion model 240 to compute a new generated inpainted motion

$$( {\tilde{H}}_{0}^{t} ) .$$

The COIN algorithm may perform the denoising steps multiple times, such as ten total denoising steps. Subsequently, the final inpainted motion (e.g., after performing the denoising steps ten times) is provided back to the optimization block 220.

The optimization block 220 utilizes the final inpainted motion in the COIN-SDS loss function to obtain a COIN-SDS loss. For instance, the COIN-SDS loss is determined based on subtracting the latest articulated object motion (H) (e.g., the initial global articulated object motion 215 in the first iteration) from the final inpainted motion (e.g., final

$${\tilde{H}}_{0}^{t} ) .$$

As such, in contrast to traditional SDS losses and among other advantages, the COIN algorithm utilizes a control branch 235 to control the motion diffusion model 240, includes multiple denoising steps, and/or further uses soft inpainting 245.

Each of the three aspects is described in further detail below. For instance, the dynamic controlled sampling is first described, which uses the control branch 235 and the motion diffusion model 240. Specifically, the training of the control branch 235 and the motion diffusion model 240 as well as using the control branch 235 and the motion diffusion model 240 is described below. For example, to generate consistent motions that are aligned with the observed evidence, the COIN system 105 attaches a control branch (Pc) 235 to the pre-trained diffusion model (D_{ϕ}) 240 to guide the motion generation. To train the controlled denoiser D_{ϕ,ϕ}_{_{c}} (e.g., the control branch 235 and the pre-trained diffusion model 240), a latent motion Hₜ, control signal c, and visible mask M are used. For instance, based on inputting the latent motion, control signal, and visible mask, the controlled denoiser generates intermediate denoised motion

$${\tilde{H}}_{0}^{t , unknown}$$

for DDIM denoising, which is shown by the below:

$${\tilde{H}}_{0}^{t , unknown} = {D}_{{ϕϕ}_{c}} ( {\tilde{H}}_{t} , t , c ⊙ M ) \qquad Eq . 6$$

where c and M are the same size as the motion, M is a binary mask with ones in observed pose dimensions, and ⊙ denotes the element-wise multiplication. During training, noise and occlusions are synthesized by randomly adding Gaussian noise to the control signal c and randomly masking the pose and trajectory dimensions in M.

After training, when using the denoiser 110 during the optimization or inference stage, instead of always using the initial noisy estimation from HybrIK as the fixed control signal, the denoiser 110 uses a dynamic control strategy. For instance, the optimized human motion from the previous iteration may be used as the control signal (e.g., c=H). By using this, it may prevent performance degradation due to inaccurate initializations as a better control signal may guide the model 240 to generate a more plausible pseudo motion, which in turn helps to optimize the global human motion and provides a control signal that better aligns with the input videos 205. Such self-evolving control signals may further help to generate well-aligned global human motions.

In some embodiments, the pre-trained motion diffusion model 240 may adopt a transformer encoder structure such as the structure described by Tevet et al. In “Human motion diffusion model” ICLR 2023, 2022, the entire contents of which is incorporated herein by reference. ControlNet, which is described by Zhang et al. In “Adding conditional control to text-to-image diffusion models”, 2023, the entire contents of which is incorporated herein by reference, may be used to encode the control signals and guide the denoiser 110 output. A trainable copy of four encoding blocks of the pre-trained motion diffusion model 240 followed with zero convolutions may be created. The input to the control branch 235 may be the concatenation of the latent and the control signals. The motion diffusion model 240 may be trained using the AMASS dataset, which is described by Mahmood et al. In “AMASS: Archive of motion capture as surface shapes”, ICCV, 2019, the entire contents of which is incorporated herein by reference. The fine-tuning of the controlled denoiser 110 may be computationally efficient because when the control branch 235 is trained, the pre-trained branch (e.g., the motion diffusion model 240) is frozen.

The third aspect (soft inpainting 245) is described in further detail below. For instance, while guiding motion generation encourages outputs to align with the conditions, it might not be strong enough in some embodiments. As such, the COIN system 105 may further seek to improve the consistency by masking the known regions and inpainting the unknown regions. For instance, given a binary mask M that indicates the observed and unobserved regions, the COIN system 105 may use the diffusion model 240 to generate the inpainted motion

$${\tilde{H}}_{0}^{t}$$

following the DDIM denoising process:

$${\tilde{H}}_{0}^{t , known} = H \qquad Eq . 7 a$$

$${\tilde{H}}_{0}^{t , unknown} = {D}_{{ϕϕ}_{c}} ( {\tilde{H}}_{t} , t , c ⊙ M ) \qquad Eq . 7 b$$

$${\tilde{H}}_{0}^{t} = \tilde{M} ⊙ {\tilde{H}}_{0}^{t , unknown} + ( 1 - \tilde{M} ) ⊙ {\tilde{H}}_{0}^{t , unknown} \qquad Rq . 7 c$$

where Eq. 7b is Eq. 6 above and Eq. 7c is Eq. 5 above.

Thus, the known regions may be overwritten with the observations, while the unknown regions are sampled from the diffusion model 240. However, the above keeps the observed parts unchanged during the denoising process. In practice, the observed parts may be noisy and not perfect, and thus the COIN system 105 may seek to refine the observed parts, but not change them significantly.

A soft inpainting strategy is presented to infill the unobserved regions while refining the observed regions by dynamically reweighting the denoised direction from the diffusion model 240. Specifically, instead of using a binary mask, the soft inpainting 245 utilizes a continuous mask M that is dependent on both the confidence score of the observations S and the denoising time step t, which is shown below:

$$\tilde{M} = ω ( t ) * S ⊙ M \qquad Eq . 8$$

where ω(t) is set as

$$max ( 0 , \frac{t - 0.5}{0.5} )$$

to linearly decrease the weight of the observations as the denoising time step decreases. S and M may be obtained from the pose estimator 120, which is described above. As the time step decreases, the denoising process may be more deterministic and the model 240 may be more certain of the generated motions.

The third aspect (e.g., multiple denoising steps) is described in further detail below. For instance, intuitively, to obtain high-quality pseudo ground truth for SDS, the single-step denoised motion

$${\hat{H}}_{0}^{t}$$

may be replaced with a multi-step one

$${\tilde{H}}_{0}^{t} := {\tilde{H}}_{0} .$$

Then, the multi-step DDIM denoising process may be performed using the below:

$${\tilde{H}}_{t - Δ t} = \sqrt{{\overline{α}}_{t - Δ t}} \cdot {\hat{H}}_{0}^{t} + \sqrt{1 - {\overline{α}}_{t - Δ t}} \cdot {ϵ}_{ϕ}^{t} \qquad Eq . 9$$

until \tilde{H}₀=\tilde{H}_{t-Δt} is obtained. By replacing

$${\hat{H}}_{0}^{t}$$

in Eq. 3 with \tilde{H}₀, a new objective for SDS may be obtained:

$${min}_{H} {L}_{SDS} := {𝔼}_{t} [ \frac{ω ( t ) \sqrt{{\overline{α}}_{t}}}{\sqrt{1 - {\overline{α}}_{t}}} {‖ H - {\tilde{H}}_{0} ‖}_{2}^{2} ] \qquad Eq . 10$$

Although the multi-step denoising process may produce high-quality pseudo ground truth, it may be computationally expensive to perform multiple denoising steps during optimization, which limits the practicality of increasing the number of denoising steps. In some embodiments, ten denoising steps may be used and may be sufficient to produce a high-quality pseudo ground truth.

Therefore, combining the three aspects described above (e.g., soft inpainting, dynamic controlled sampling, and multiple denoising steps), the final objective for the COIN-SDS may be formulated as follows:

$${min}_{H} {L}_{COIN - SDS} := {𝔼}_{t} [ \frac{ω ( t ) \sqrt{{\overline{α}}_{t}}}{\sqrt{1 - {\overline{α}}_{t}}} {‖ H - {\tilde{H}}_{0} ( H , M , S , t ) ‖}_{2}^{2} ] \qquad Eq . 11$$

After determining the COIN-SDS loss, the optimization block 220 determines the gradients 180 and then uses the gradients 180 to update the camera motion 165 as well as the global articulated object motion 170. For instance, utilizing Eq. 11 (e.g., a loss function 225), the COIN-SDS loss may be determined and used to compute the gradients 180. Then, the COIN system 105 may update the camera motion 165 and the global articulated object motion 170 using the gradients 180 and ADAM.

Additionally, and/or alternatively, as will be explained below, the losses 175 may include the COIN-SDS loss and one or more additional losses such as a re-projection loss. The re-projection loss may be determined using both the camera motion 165 and global articulated object motion 170. The gradient 180 may be determined based on losses 175 including the COIN-SDS loss and/or the re-projection loss. Following, as described above, using one or more algorithms and/or processes such as using an ADAM optimizer, the camera motion 165 and global articulated object motion 170 may be updated.

After updating the camera motion 165 and global articulated object motion 170, the COIN algorithm is repeated. For instance, now, the latest articulated object motion (H) is not the initial global articulated object motion 170, but rather the global articulated object motion 170 that was updated based on the COIN-SDS loss and/or additional losses from the previous iteration. The process may repeat one or more times until a threshold is reached, and then the global articulated object motion 170 and the camera motion 165 are provided as output, and used for one or more tasks such as robotics and/or animation.

FIG. 2B shows a summary 260 of the COIN algorithm that is described above. Specifically, the input for the COIN-SDS algorithm may include the latest human motion, confidence score, and visible mask, and the output of the algorithm may be the COIN-SDS loss. In the first line, a distribution is sampled as described above. Then, in the second line, multi-step denoising is performed based on executing steps 3-8. In the third line, the known regions are determined. In a fourth line, the controlled motion denoiser 110 is used to determine the unknown regions. In the fifth line, the continuous mask is determined. In the sixth step, soft inpainting 245 is performed. In the seventh line, the predicted denoising direction from the diffusion model is determined. In the eighth line, the denoised motion for the particular DDIM denoising step is determined. In the ninth line, the COIN-SDS loss is determined.

Referring back to FIG. 2A, in an embodiment, the COIN system 105 may further use one or more additional loss functions for the optimization. For example, in each iteration, the optimization block 220 may use one or more loss functions 225 such as the COIN-SDS loss function that is described above (e.g., Eq. 11) and/or additional loss functions. The additional loss functions may include a human-scene relation loss (e.g., L_{HSR}) and/or a body loss (e.g., L_{body}), which may include the re-projection loss described above. For instance, the COIN-SDS loss may be configured for global human motion estimation, but the COIN system 105 may further use the human-scene relation loss that uses the depth relation between the human and scene in the camera space, which disentangles the effect of the camera itself. The human-scene relation loss may be determined based on a scaled point cloud of the scene, a transformed point in the i-th frame, the body joint that is the nearest 2D projection to the scene point p in the i-th frame, and a depth of a given point. The 2D projection and the depth of the body joint may be directly obtained from the initial local human motion (e.g., local human motion 160). The local human motion 160 includes the joint positions, and thus, using re-projection, the depth of the joint may be retrieved. The scaled point cloud may be obtained from SLAM 125, where the initial camera motion 165 may also be obtained. The point cloud and the camera motion share a same scale. Further, back-propagation may be performed to obtain the scale and this may be updated with the ADAM optimizer. The human-scene relation loss is further described below and in Eq. 14.

In other words, in some embodiments, the global optimization may include using the COIN-SDS loss that is described above along with other losses. For instance, in some embodiments, the overall optimization pipeline for the joint estimation of global human and camera motion uses COIN-SDS loss and one or more additional losses. For example, SLAM is first used to initialize the camera poses, which is scale-ambiguous. Therefore, jointly optimizing the camera scale s with the human and camera motions may be used. Furthermore, the SLAM method assumes the camera in the first frame to be at the origin. To put the human motion in the correct positions, PACE is followed and also optimizing the camera height h₀ and the rotation R₀ for the first frame is performed. The global human motions are initialized by the estimated local motions and the camera poses. The overall optimization objective is described below:

$${min}_{H , C , s , {h}_{0} , {R}_{0} , β} {L}_{body} + {L}_{COIN - SDS} + {L}_{HSR} \qquad Eq . 12$$

$$where$$

$${L}_{body} = {L}_{2 D} + {L}_{3 D} + {L}_{β} + {L}_{smooth} + {L}_{contact} \qquad Eq . 13$$

L_{2D} measures the 2D projection error between the projected 2D body joints of the estimated human motion and the detected 2D keypoints from an off-the-shelf 2D joint detector. L_{3D} measures the distance between the estimated local 3D joints and the detected 3D joints from an off-the-shelf 3D joint detector. L_{β} is the shape regularization loss. Lₛₘₒₒₜₕ is the temporal smoothness loss. L_{contact} is the foot contact loss to encourage zero velocities for contact joints. The contact labels are obtained from the pseudo ground truth motion from COIN-SDS. L_{body} including its components are described in further detail in U.S. patent application Ser. No. 18/135,654 titled “Camera and articulated object motion estimation from video,” filed Apr. 17, 2023, and U.S. patent application Ser. No. 17/584,213 titled “Performing occlusion-aware global 3d pose and shape estimation of articulated objects,” filed Jan. 25, 2022, the entire contents of which are incorporated herein by reference.

The L_{COIN-SDS} is described above and the L_{HSR} is a human-scene relation loss, which will be described in further detail below. For instance, the camera trajectories recovered from SLAM may be scale-ambiguous. Conventional methods may optimize the camera scale by projecting the global human motion to the camera space using the camera poses and minimizing the reprojection error. However, such a method entirely relies on the global human motions, which is in turn affected by the camera scale. If the human motion is not initialized well, the camera scale may also be inaccurate. As such, instead of the global human motions, the COIN system 105 may use a human-scene relation loss that uses the depth relation between the human and scene in the camera space, which disentangles the effect of the camera itself.

For instance, the point cloud of the scene may be recovered by SLAM and used as a constraint. First of all, the scale of the scene point cloud may be the same as the camera scale, so optimizing the scene scale is equivalent to optimizing the camera scale. Second, the scene points that are projected onto the visible vertices of the body mesh may be occluded by the person. Otherwise, the corresponding body parts may be invisible. Therefore, the COIN system 105 may constrain the depth of the occluded scene points to be larger than the depth of the human body vertices. While finding the corresponding body vertices for each scene point may be time-consuming, the COIN system 105 may use the depth of its nearest body joint as a proxy. Given the scene point cloud P and the camera scale s, the human-scene relation loss may be formulated as:

$${L}_{HSR} = \frac{1}{\vert P \vert} {\sum }_{i = 1}^{T} {\sum }_{p ∈ {P}^{*}} min ( 0 , {{T}^{( i )} ( p )}_{z} - {{j}^{( i )} ( p )}_{z} ) \cdot 1 ( {T}^{( i )} ( p ) is invisible ) \qquad EQ . 14$$

where P^{*}=P*s is the scaled point cloud of the scene, T⁽ⁱ⁾(p)=R⁽ⁱ⁾p+t⁽ⁱ⁾ is the transformed point in the i-th frame, j⁽ⁱ⁾(p) is the body joint that has the nearest 2D projection to the scene point p in the i-th frame, and z denotes the depth of a given point. If the depth order is correct (e.g., T⁽ⁱ⁾(p)_{z}−j⁽ⁱ⁾(p)_{z}>0), the loss is zero. The human-scene relation loss may use the relation between the local motions and the scene to alleviate the scale ambiguity. The depth relation regularizes consistency among humans, cameras, and scenes.

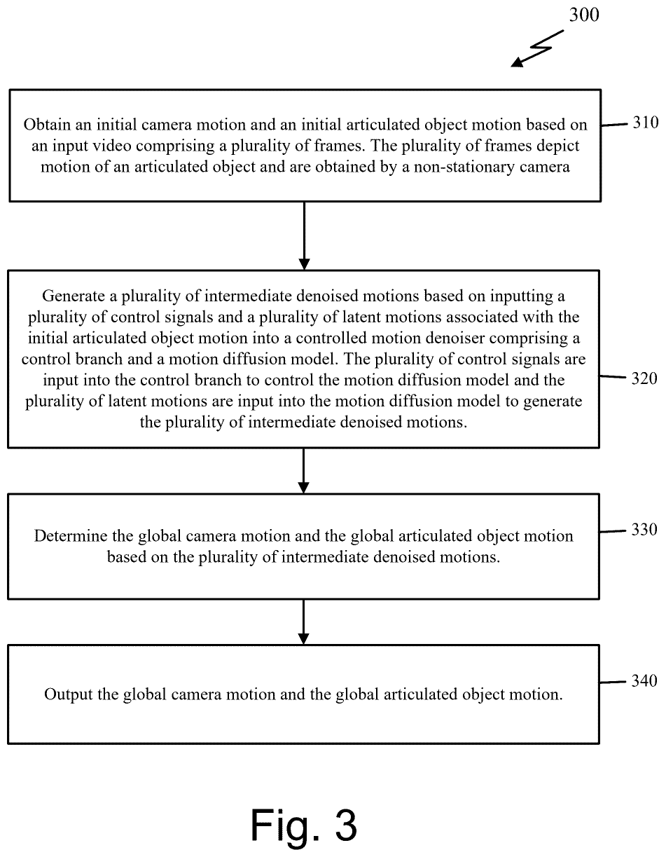

FIG. 3 illustrates a flowchart of a method for using the COIN algorithm and the COIN system, in accordance with an embodiment. Each block of method 300, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the COIN system 105 of FIGS. 1A and 1B and framework 200 of FIG. 2A. However, this method may additionally or alternatively be executed by any one system, or any combination of systems, including, but not limited to, those described herein. Furthermore, persons of ordinary skill in the art will understand that any system that performs method 300 is within the scope and spirit of embodiments of the present disclosure.

At step 310, an initial camera motion and an initial articulated object motion is obtained based on an input video comprising a plurality of frames. For instance, an initial articulated object motion of an articulated object is determined based on an input video comprising a plurality of frames that depict motion of the articulated object. The input video is obtained by a non-stationary camera and the initial articulated object motion is in a local coordinate system associated with the non-stationary camera. Further, based on the input video, the initial camera motion is determined in a global coordinate system that is a real-world coordinate system. In an embodiment, determining the initial camera motion may be based on using a Simultaneous Localization and Mapping (SLAM) algorithm and determining the initial articulated object motion may be based on using a 3-dimensional (3-D) Pose Estimator.

At step 320, a plurality of intermediate denoised motions are generated based on inputting a plurality of control signals and a plurality of latent motions associated with the initial articulated object motion into a controlled motion denoiser comprising a control branch and a motion diffusion model. The plurality of control signals are input into the control branch to control the motion diffusion model and the plurality of latent motions are input into the motion diffusion model to generate the plurality of intermediate denoised motions. In an embodiment, generating the one or more intermediate denoised motions comprises generating a first noisy latent distribution based on combining the initial articulated object motion with a noise signal, sampling the first noisy latent distribution to generate initial latent motion from the plurality of latent motions, and processing the initial latent motion according to a first control signal, from the plurality of control signals, to produce a first intermediate denoised motion. The first control signal is the initial articulated object motion.

In an embodiment, generating the one or more intermediate denoised motion further comprises updating the initial articulated object motion to generate one or more updated articulated object motions based on the first intermediate denoised motion, generating one or more second noisy latent distributions based on combining the one or more updated articulated object motions with the noise signal, sampling the one or more second noisy latent distributions to generate one or more second latent motions from the plurality of latent motions, and processing the one or more second latent motions according to one or more second control signals, from the plurality of control signals, to produce one or more second intermediate denoised motions. The one or more second control signals are based on the one or more updated articulated object motions.

At step 330, the global camera motion and the global articulated object motion are determined based on the plurality of intermediate denoised motions. The global camera motion and the global articulated object motion are both in the global coordinate system. In an embodiment, the initial articulated object motion is converted from the local coordinate system to the global coordinate system. Further, the global camera motion and the global articulated object motion are determined by refining the initial articulated object motion that has been converted to the global coordinate system using the plurality of intermediate denoised motions. In an embodiment, determining the global camera motion and the global articulated object motion comprises determining known articulated object motions of the input video based on the initial articulated object motion, determining unknown articulated object motions of the input video based on the plurality of intermediate denoised motions generated using the controlled motion denoiser, determining a Control-Inpainting Score Distillation Sampling (COIN-SDS) loss based on the known articulated object motions and the unknown articulated object motions, and determining the global camera motion and the global articulated object motion based on the COIN-SDS loss.

In an embodiment, determining the COIN-SDS loss comprises generating one or more inpainted motions based on the known articulated object motions, the unknown articulated object motions, and a continuous mask and determining the COIN-SDS loss based on the one or more inpainted motions. The continuous mask is associated with a denoising step and a confidence score of the observations. In an embodiment, generating one or more inpainted motions comprises generating a plurality of inpainted motions. Each of the plurality of inpainted motions is associated with a different denoising step of a plurality of denoising steps and a final inpainted motion, from the plurality of inpainted motions, is used to determine the COIN-SDS loss.

In an embodiment, determining the global camera motion and the global articulated object motion comprises determining a Control-Inpainting Score Distillation Sampling (COIN-SDS) loss based on using the controlled motion denoiser and the plurality of intermediate denoised motions, determining a human-scene relation loss based on a point cloud associated with the initial camera motion, and determining the global camera motion and the global articulated object motion using the COIN-SDS loss and the human-scene relation loss. In an embodiment, determining the global camera motion and the global articulated object motion is further based on a body loss that is determined based on the initial camera motion and/or the initial articulated object motion. The body loss comprises a re-projection loss.

At step 340, the global camera motion and the global articulated object motion are output. In an embodiment, outputting the global camera motion and the global articulated object motion comprises using the global camera motion and the global articulated object motion to control one or more robotic systems.

In an embodiment, the method 300 may further include training the motion diffusion model using one or more first datasets, subsequent to training the motion diffusion model, freezing parameters of the trained motion diffusion model, and after connecting the control branch to the trained motion diffusion model, training the control branch using one or more second datasets.

In an embodiment, at least one of steps 310-340 are performed on a server or in a data center to determine the global camera motion and the global articulated object motion, and the global camera motion and the global articulated object motion are streamed to a user device. In an embodiment, at least one of steps 310-340 is performed within a cloud computing environment. In an embodiment, at least one of steps 310-340 is performed for training, testing, or certifying a neural network employed in a machine, robot, or autonomous vehicle. In an embodiment, at least one of steps 310-340 is performed on a virtual machine comprising a portion of a graphics processing unit.

In some examples, embodiments of the present disclosure include a COIN system 105 and use a COIN algorithm for estimating the global motion 130 (e.g., the global articulated object motion 170 and the camera motion 165) from dynamic cameras. For instance, the COIN system 105 uses a controlled denoiser 110 combined with soft inpainting 245 to ensure well-aligned consistent, and high quality motion from the diffusion prior within a joint optimization framework. Additionally, and/or alternatively, embodiments of the present disclosure may use a human-scene relation loss to alleviate the scale ambiguity by enforcing consistency among the humans, camera, and scene. Using embodiments of the present disclosure, it has been demonstrated that the embodiments outperform state-of-the-art methods by substantial amounts. Furthermore, embodiments of the present disclosure have been implemented on both synthetic and real-world datasets, and have demonstrated that the COIN system 105 and algorithm is able to recover accurate global articulated object motion 170 and camera motion 165.

### Parallel Processing Architecture

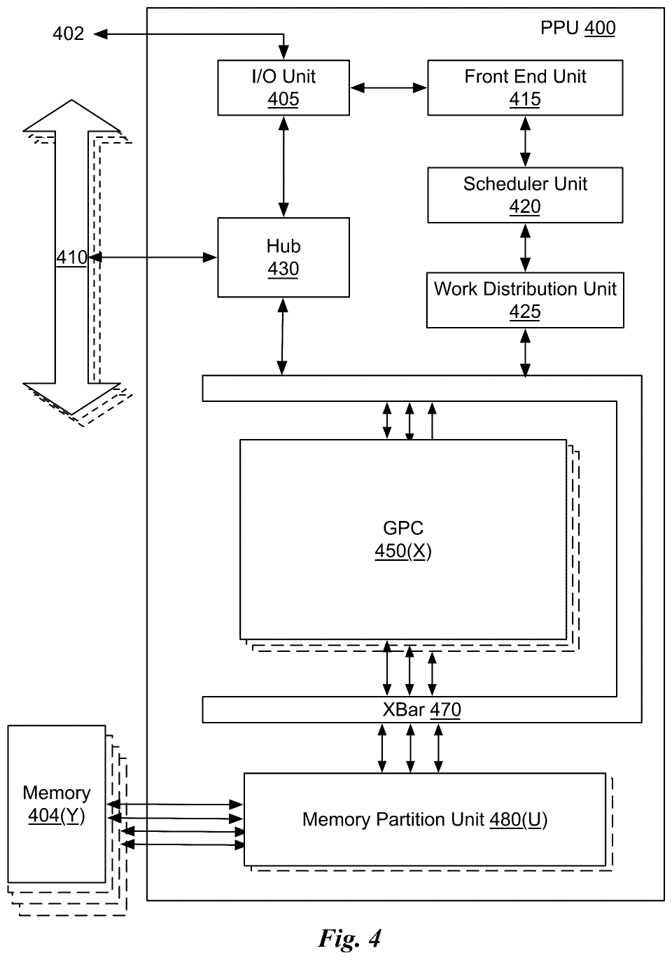

FIG. 4 illustrates a parallel processing unit (PPU) 400, in accordance with an embodiment. The PPU 400 may be used to estimate the global motion 130 (e.g., the global articulated object motion 170 and the camera motion 165) using the COIN system 105 having a controlled motion denoiser 110. In an embodiment, a processor such as the PPU 400 may be configured to implement a neural network model. The neural network model may be implemented as software instructions executed by the processor or, in other embodiments, the processor can include a matrix of hardware elements configured to process a set of inputs (e.g., electrical signals representing values) to generate a set of outputs, which can represent activations of the neural network model. In yet other embodiments, the neural network model can be implemented as a combination of software instructions and processing performed by a matrix of hardware elements. Implementing the neural network model can include determining a set of parameters for the neural network model through, e.g., supervised or unsupervised training of the neural network model as well as, or in the alternative, performing inference using the set of parameters to process novel sets of inputs.

In an embodiment, the PPU 400 is a multi-threaded processor that is implemented on one or more integrated circuit devices. The PPU 400 is a latency hiding architecture designed to process many threads in parallel. A thread (e.g., a thread of execution) is an instantiation of a set of instructions configured to be executed by the PPU 400. In an embodiment, the PPU 400 is a graphics processing unit (GPU) configured to implement a graphics rendering pipeline for processing three-dimensional (3D) graphics data in order to generate two-dimensional (2D) image data for display on a display device. In other embodiments, the PPU 400 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more PPUs 400 may be configured to accelerate thousands of High Performance Computing (HPC), data center, cloud computing, and machine learning applications. The PPU 400 may be configured to accelerate numerous deep learning systems and applications for autonomous vehicles, simulation, computational graphics such as ray or path tracing, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 4, the PPU 400 includes an Input/Output (I/O) unit 405, a front end unit 415, a scheduler unit 420, a work distribution unit 425, a hub 430, a crossbar (Xbar) 470, one or more general processing clusters (GPCs) 450, and one or more memory partition units 480. The PPU 400 may be connected to a host processor or other PPUs 400 via one or more high-speed NVLink 410 interconnect. The PPU 400 may be connected to a host processor or other peripheral devices via an interconnect 402. The PPU 400 may also be connected to a local memory 404 comprising a number of memory devices. In an embodiment, the local memory may comprise a number of dynamic random access memory (DRAM) devices. The DRAM devices may be configured as a high-bandwidth memory (HBM) subsystem, with multiple DRAM dies stacked within each device.

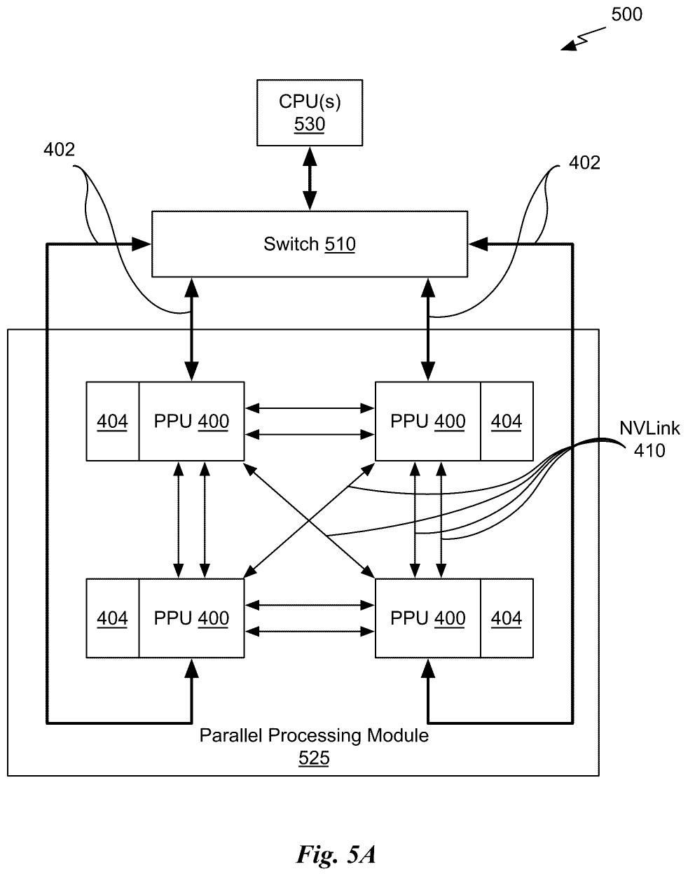

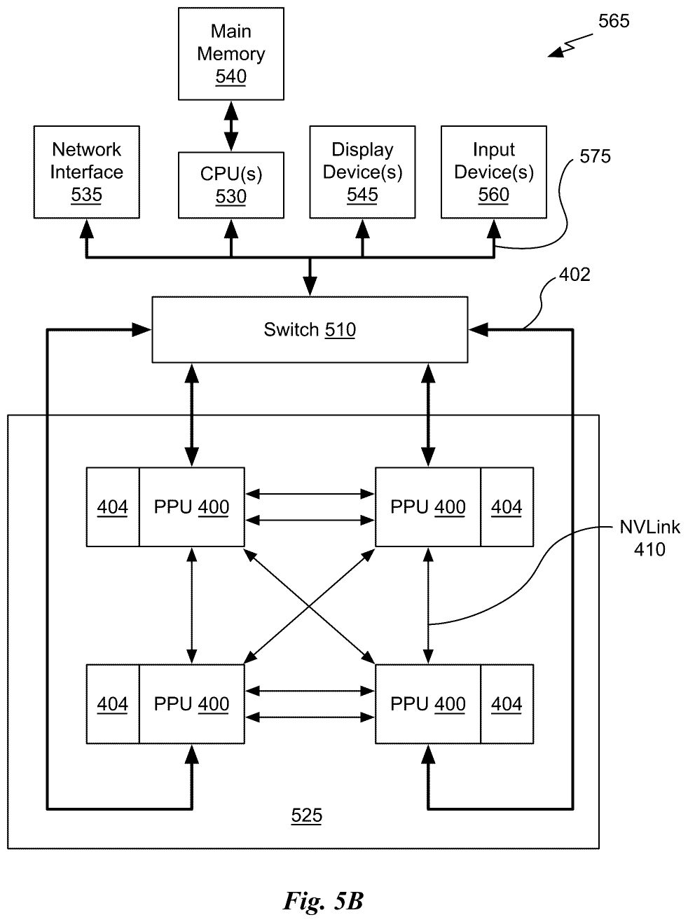

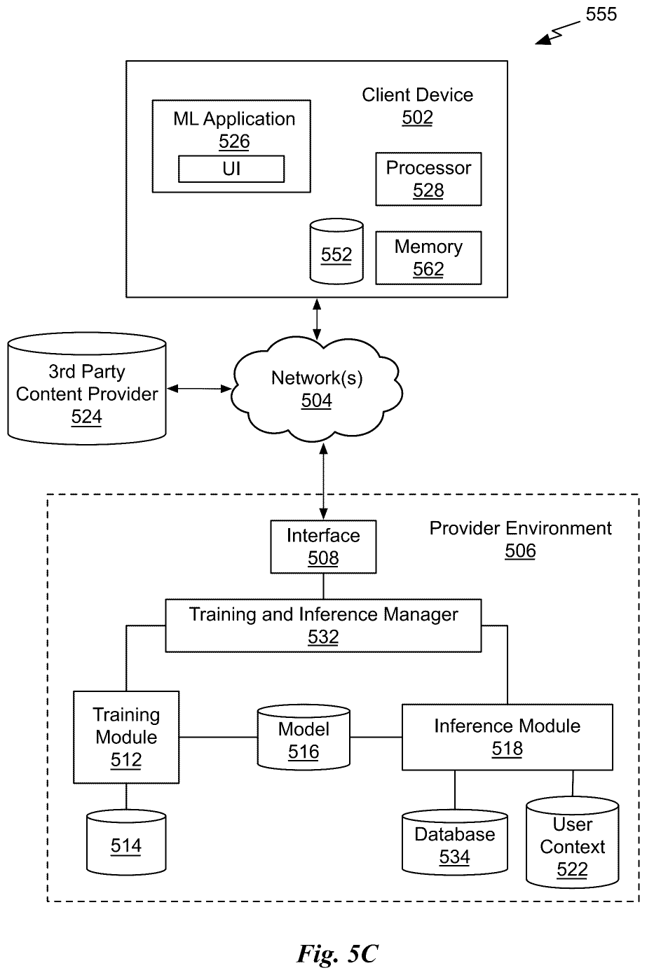

The NVLink 410 interconnect enables systems to scale and include one or more PPUs 400 combined with one or more CPUs, supports cache coherence between the PPUs 400 and CPUs, and CPU mastering. Data and/or commands may be transmitted by the NVLink 410 through the hub 430 to/from other units of the PPU 400 such as one or more copy engines, a video encoder, a video decoder, a power management unit, etc. (not explicitly shown). The NVLink 410 is described in more detail in conjunction with FIG. 5B.

The I/O unit 405 is configured to transmit and receive communications (e.g., commands, data, etc.) from a host processor (not shown) over the interconnect 402. The I/O unit 405 may communicate with the host processor directly via the interconnect 402 or through one or more intermediate devices such as a memory bridge. In an embodiment, the I/O unit 405 may communicate with one or more other processors, such as one or more the PPUs 400 via the interconnect 402. In an embodiment, the I/O unit 405 implements a Peripheral Component Interconnect Express (PCIe) interface for communications over a PCIe bus and the interconnect 402 is a PCIe bus. In alternative embodiments, the I/O unit 405 may implement other types of well-known interfaces for communicating with external devices.

The I/O unit 405 decodes packets received via the interconnect 402. In an embodiment, the packets represent commands configured to cause the PPU 400 to perform various operations. The I/O unit 405 transmits the decoded commands to various other units of the PPU 400 as the commands may specify. For example, some commands may be transmitted to the front end unit 415. Other commands may be transmitted to the hub 430 or other units of the PPU 400 such as one or more copy engines, a video encoder, a video decoder, a power management unit, etc. (not explicitly shown). In other words, the I/O unit 405 is configured to route communications between and among the various logical units of the PPU 400.

In an embodiment, a program executed by the host processor encodes a command stream in a buffer that provides workloads to the PPU 400 for processing. A workload may comprise several instructions and data to be processed by those instructions. The buffer is a region in a memory that is accessible (e.g., read/write) by both the host processor and the PPU 400. For example, the I/O unit 405 may be configured to access the buffer in a system memory connected to the interconnect 402 via memory requests transmitted over the interconnect 402. In an embodiment, the host processor writes the command stream to the buffer and then transmits a pointer to the start of the command stream to the PPU 400. The front end unit 415 receives pointers to one or more command streams. The front end unit 415 manages the one or more streams, reading commands from the streams and forwarding commands to the various units of the PPU 400.

The front end unit 415 is coupled to a scheduler unit 420 that configures the various GPCs 450 to process tasks defined by the one or more streams. The scheduler unit 420 is configured to track state information related to the various tasks managed by the scheduler unit 420. The state may indicate which GPC 450 a task is assigned to, whether the task is active or inactive, a priority level associated with the task, and so forth. The scheduler unit 420 manages the execution of a plurality of tasks on the one or more GPCs 450.

The scheduler unit 420 is coupled to a work distribution unit 425 that is configured to dispatch tasks for execution on the GPCs 450. The work distribution unit 425 may track a number of scheduled tasks received from the scheduler unit 420. In an embodiment, the work distribution unit 425 manages a pending task pool and an active task pool for each of the GPCs 450. As a GPC 450 finishes the execution of a task, that task is evicted from the active task pool for the GPC 450 and one of the other tasks from the pending task pool is selected and scheduled for execution on the GPC 450. If an active task has been idle on the GPC 450, such as while waiting for a data dependency to be resolved, then the active task may be evicted from the GPC 450 and returned to the pending task pool while another task in the pending task pool is selected and scheduled for execution on the GPC 450.

In an embodiment, a host processor executes a driver kernel that implements an application programming interface (API) that enables one or more applications executing on the host processor to schedule operations for execution on the PPU 400. In an embodiment, multiple compute applications are simultaneously executed by the PPU 400 and the PPU 400 provides isolation, quality of service (QOS), and independent address spaces for the multiple compute applications. An application may generate instructions (e.g., API calls) that cause the driver kernel to generate one or more tasks for execution by the PPU 400. The driver kernel outputs tasks to one or more streams being processed by the PPU 400. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. The tasks may be allocated to one or more processing units within a GPC 450 and instructions are scheduled for execution by at least one warp.

The work distribution unit 425 communicates with the one or more GPCs 450 via XBar 470. The XBar 470 is an interconnect network that couples many of the units of the PPU 400 to other units of the PPU 400. For example, the XBar 470 may be configured to couple the work distribution unit 425 to a particular GPC 450. Although not shown explicitly, one or more other units of the PPU 400 may also be connected to the XBar 470 via the hub 430.

The tasks are managed by the scheduler unit 420 and dispatched to a GPC 450 by the work distribution unit 425. The GPC 450 is configured to process the task and generate results. The results may be consumed by other tasks within the GPC 450, routed to a different GPC 450 via the XBar 470, or stored in the memory 404. The results can be written to the memory 404 via the memory partition units 480, which implement a memory interface for reading and writing data to/from the memory 404. The results can be transmitted to another PPU 400 or CPU via the NVLink 410. In an embodiment, the PPU 400 includes a number U of memory partition units 480 that is equal to the number of separate and distinct memory devices of the memory 404 coupled to the PPU 400. Each GPC 450 may include a memory management unit to provide translation of virtual addresses into physical addresses, memory protection, and arbitration of memory requests. In an embodiment, the memory management unit provides one or more translation lookaside buffers (TLBs) for performing translation of virtual addresses into physical addresses in the memory 404.

In an embodiment, the memory partition unit 480 includes a Raster Operations (ROP) unit, a level two (L2) cache, and a memory interface that is coupled to the memory 404. The memory interface may implement 32, 64, 128, 1024-bit data buses, or the like, for high-speed data transfer. The PPU 400 may be connected to up to Y memory devices, such as high bandwidth memory stacks or graphics double-data-rate, version 5, synchronous dynamic random access memory, or other types of persistent storage. In an embodiment, the memory interface implements an HBM2 memory interface and Y equals half U. In an embodiment, the HBM2 memory stacks are located on the same physical package as the PPU 400, providing substantial power and area savings compared with conventional GDDR5 SDRAM systems. In an embodiment, each HBM2 stack includes four memory dies and Y equals 4, with each HBM2 stack including two 128-bit channels per die for a total of 8 channels and a data bus width of 1024 bits.

In an embodiment, the memory 404 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 400 process very large datasets and/or run applications for extended periods.

In an embodiment, the PPU 400 implements a multi-level memory hierarchy. In an embodiment, the memory partition unit 480 supports a unified memory to provide a single unified virtual address space for CPU and PPU 400 memory, enabling data sharing between virtual memory systems. In an embodiment the frequency of accesses by a PPU 400 to memory located on other processors is traced to ensure that memory pages are moved to the physical memory of the PPU 400 that is accessing the pages more frequently. In an embodiment, the NVLink 410 supports address translation services allowing the PPU 400 to directly access a CPU's page tables and providing full access to CPU memory by the PPU 400.

In an embodiment, copy engines transfer data between multiple PPUs 400 or between PPUs 400 and CPUs. The copy engines can generate page faults for addresses that are not mapped into the page tables. The memory partition unit 480 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 404 or other system memory may be fetched by the memory partition unit 480 and stored in the L2 cache 460, which is located on-chip and is shared between the various GPCs 450. As shown, each memory partition unit 480 includes a portion of the L2 cache associated with a corresponding memory 404. Lower level caches may then be implemented in various units within the GPCs 450. For example, each of the processing units within a GPC 450 may implement a level one (L1) cache. The L1 cache is private memory that is dedicated to a particular processing unit. The L2 cache 460 is coupled to the memory interface 470 and the XBar 470 and data from the L2 cache may be fetched and stored in each of the L1 caches for processing.

In an embodiment, the processing units within each GPC 450 implement a SIMD (Single-Instruction, Multiple-Data) architecture where each thread in a group of threads (e.g., a warp) is configured to process a different set of data based on the same set of instructions. All threads in the group of threads execute the same instructions. In another embodiment, the processing unit implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

Each processing unit includes a large number (e.g., 128, etc.) of distinct processing cores (e.g., functional units) that may be fully-pipelined, single-precision, double-precision, and/or mixed precision and include a floating point arithmetic logic unit and an integer arithmetic logic unit. In an embodiment, the floating point arithmetic logic units implement the IEEE 754-2008 standard for floating point arithmetic. In an embodiment, the cores include 64 single-precision (32-bit) floating point cores, 64 integer cores, 32 double-precision (64-bit) floating point cores, and 8 tensor cores.

Tensor cores configured to perform matrix operations. In particular, the tensor cores are configured to perform deep learning matrix arithmetic, such as GEMM (matrix-matrix multiplication) for convolution operations during neural network training and inferencing. In an embodiment, each tensor core operates on a 4×4 matrix and performs a matrix multiply and accumulate operation D=A×B+C, where A, B, C, and D are 4×4 matrices.

In an embodiment, the matrix multiply inputs A and B may be integer, fixed-point, or floating point matrices, while the accumulation matrices C and D may be integer, fixed-point, or floating point matrices of equal or higher bitwidths. In an embodiment, tensor cores operate on one, four, or eight bit integer input data with 32-bit integer accumulation. The 8-bit integer matrix multiply requires 1024 operations and results in a full precision product that is then accumulated using 32-bit integer addition with the other intermediate products for a 8×8×16 matrix multiply. In an embodiment, tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each processing unit may also comprise M special function units (SFUs) that perform special functions (e.g., attribute evaluation, reciprocal square root, and the like). In an embodiment, the SFUs may include a tree traversal unit configured to traverse a hierarchical tree data structure. In an embodiment, the SFUs may include texture unit configured to perform texture map filtering operations. In an embodiment, the texture units are configured to load texture maps (e.g., a 2D array of texels) from the memory 404 and sample the texture maps to produce sampled texture values for use in shader programs executed by the processing unit. In an embodiment, the texture maps are stored in shared memory that may comprise or include an L1 cache. The texture units implement texture operations such as filtering operations using mip-maps (e.g., texture maps of varying levels of detail). In an embodiment, each processing unit includes two texture units.

Each processing unit also comprises N load store units (LSUs) that implement load and store operations between the shared memory and the register file. Each processing unit includes an interconnect network that connects each of the cores to the register file and the LSU to the register file, shared memory. In an embodiment, the interconnect network is a crossbar that can be configured to connect any of the cores to any of the registers in the register file and connect the LSUs to the register file and memory locations in shared memory.

The shared memory is an array of on-chip memory that allows for data storage and communication between the processing units and between threads within a processing unit. In an embodiment, the shared memory comprises 128 KB of storage capacity and is in the path from each of the processing units to the memory partition unit 480. The shared memory can be used to cache reads and writes. One or more of the shared memory, L1 cache, L2 cache, and memory 404 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory enables the shared memory to function as a high-throughput conduit for streaming data while simultaneously providing high-bandwidth and low-latency access to frequently reused data.

When configured for general purpose parallel computation, a simpler configuration can be used compared with graphics processing. Specifically, fixed function graphics processing units, are bypassed, creating a much simpler programming model. In the general purpose parallel computation configuration, the work distribution unit 425 assigns and distributes blocks of threads directly to the processing units within the GPCs 450. Threads execute the same program, using a unique thread ID in the calculation to ensure each thread generates unique results, using the processing unit(s) to execute the program and perform calculations, shared memory to communicate between threads, and the LSU to read and write global memory through the shared memory and the memory partition unit 480. When configured for general purpose parallel computation, the processing units can also write commands that the scheduler unit 420 can use to launch new work on the processing units.

The PPUs 400 may each include, and/or be configured to perform functions of, one or more processing cores and/or components thereof, such as Tensor Cores (TCs), Tensor Processing Units (TPUs), Pixel Visual Cores (PVCs), Ray Tracing (RT) Cores, Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The PPU 400 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 400 is embodied on a single semiconductor substrate. In another embodiment, the PPU 400 is included in a system-on-a-chip (SoC) along with one or more other devices such as additional PPUs 400, the memory 404, a reduced instruction set computer (RISC) CPU, a memory management unit (MMU), a digital-to-analog converter (DAC), and the like.

In an embodiment, the PPU 400 may be included on a graphics card that includes one or more memory devices. The graphics card may be configured to interface with a PCIe slot on a motherboard of a desktop computer. In yet another embodiment, the PPU 400 may be an integrated graphics processing unit (iGPU) or parallel processor included in the chipset of the motherboard. In yet another embodiment, the PPU 400 may be realized in reconfigurable hardware. In yet another embodiment, parts of the PPU 400 may be realized in reconfigurable hardware.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 5A is a conceptual diagram of a processing system 500 implemented using the PPU 400 of FIG. 4, in accordance with an embodiment. The exemplary system 500 may be configured to implement the global human and camera motion estimation with motion diffusion model. The processing system 500 includes a CPU 530, switch 510, and multiple PPUs 400, and respective memories 404.

The NVLink 410 provides high-speed communication links between each of the PPUs 400. Although a particular number of NVLink 410 and interconnect 402 connections are illustrated in FIG. 5B, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 5A, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 5A, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

FIG. 5B illustrates an exemplary system 565 in which the various architecture and/or functionality of the various previous embodiments may be implemented. The exemplary system 565 may be configured to implement the global human and camera motion estimation with motion diffusion model.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5B are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5B is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5B.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 5A and/or exemplary system 565 of FIG. 5B—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 5A and/or exemplary system 565 of FIG. 5B. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5C illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506.

In at least one embodiment, supervised and/or unsupervised training can be performed by the client device 502 and/or the provider environment 506. In at least one embodiment, a set of training data 514 (e.g., classified or labeled data) is provided as input to function as training data. In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache 460 and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

A graphics processing pipeline may be implemented via an application executed by a host processor, such as a CPU. In an embodiment, a device driver may implement an application programming interface (API) that defines various functions that can be utilized by an application in order to generate graphical data for display. The device driver is a software program that includes a plurality of instructions that control the operation of the PPU 400. The API provides an abstraction for a programmer that lets a programmer utilize specialized graphics hardware, such as the PPU 400, to generate the graphical data without requiring the programmer to utilize the specific instruction set for the PPU 400. The application may include an API call that is routed to the device driver for the PPU 400. The device driver interprets the API call and performs various operations to respond to the API call. In some instances, the device driver may perform operations by executing instructions on the CPU. In other instances, the device driver may perform operations, at least in part, by launching operations on the PPU 400 utilizing an input/output interface between the CPU and the PPU 400. In an embodiment, the device driver is configured to implement the graphics processing pipeline utilizing the hardware of the PPU 400.

Various programs may be executed within the PPU 400 in order to implement the various stages of the graphics processing pipeline. For example, the device driver may launch a kernel on the PPU 400 to perform a vertex shading stage on one processing unit (or multiple processing units). The device driver (or the initial kernel executed by the PPU 400) may also launch other kernels on the PPU 400 to perform other stages of the graphics processing pipeline, such as a geometry shading stage and a fragment shading stage. In addition, some of the stages of the graphics processing pipeline may be implemented on fixed unit hardware such as a rasterizer or a data assembler implemented within the PPU 400. It will be appreciated that results from one kernel may be processed by one or more intervening fixed function hardware units before being processed by a subsequent kernel on a processing unit.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), GOOGLE STADIA, and the like.

### Example Streaming System

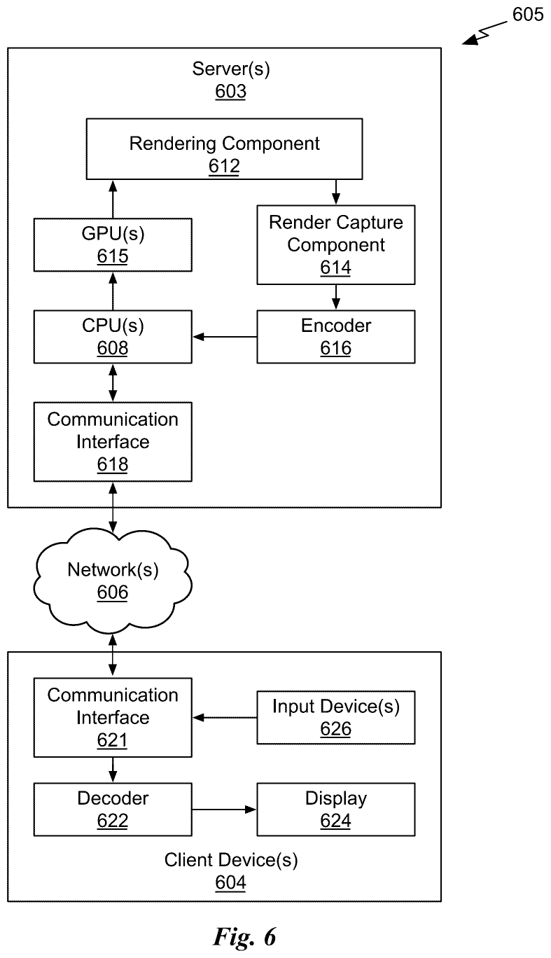

FIG. 6 is an example system diagram for a streaming system 605, in accordance with some embodiments of the present disclosure. FIG. 6 includes server(s) 603 (which may include similar components, features, and/or functionality to the example processing system 500 of FIG. 5A and/or exemplary system 565 of FIG. 5B), client device(s) 604 (which may include similar components, features, and/or functionality to the example processing system 500 of FIG. 5A and/or exemplary system 565 of FIG. 5B), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A computer-implemented method, comprising:
determining an initial articulated object motion of an articulated object based on an input video comprising a plurality of frames that depict motion of the articulated object, wherein the input video is obtained by a non-stationary camera, wherein the initial articulated object motion is in a local coordinate system associated with the non-stationary camera;
determining, based on the input video, the initial camera motion in a global coordinate system that is a real-world coordinate system;
generating a plurality of intermediate denoised motions based on inputting a plurality of control signals and a plurality of latent motions associated with the initial articulated object motion into a controlled motion denoiser comprising a control branch and a motion diffusion model, wherein the plurality of control signals are input into the control branch to control the motion diffusion model and the plurality of latent motions are input into the motion diffusion model to generate the plurality of intermediate denoised motions;
determining a global camera motion and a global articulated object motion based on the plurality of intermediate denoised motions, wherein the global camera motion and the global articulated object motion are both in the global coordinate system; and
outputting the global camera motion and the global articulated object motion.

2. The computer-implemented method of claim 1, further comprising:
converting the initial articulated object motion from the local coordinate system to the global coordinate system, and
wherein determining the global articulated object motion based on the plurality of intermediate denoised motions comprises refining the initial articulated object motion that has been converted to the global coordinate system using the plurality of intermediate denoised motions.

3. The computer-implemented method of claim 1, wherein determining the initial camera motion is based on using a Simultaneous Localization and Mapping (SLAM) algorithm, and wherein determining the initial articulated object motion is based on using a 3-dimensional (3-D) Pose Estimator.

4. The computer-implemented method of claim 1, further comprising:
training the motion diffusion model using one or more first datasets;
subsequent to training the motion diffusion model, freezing parameters of the trained motion diffusion model; and
after connecting the control branch to the trained motion diffusion model, training the control branch using one or more second datasets.

5. The computer-implemented method of claim 1, wherein generating the one or more intermediate denoised motions comprises:
generating a first noisy latent distribution based on combining the initial articulated object motion with a noise signal;
sampling the first noisy latent distribution to generate initial latent motion from the plurality of latent motions; and
processing the initial latent motion according to a first control signal, from the plurality of control signals, to produce a first intermediate denoised motion, wherein the first control signal is the initial articulated object motion.

6. The computer-implemented method of claim 5, wherein generating the one or more intermediate denoised motion further comprises:
updating the initial articulated object motion to generate one or more updated articulated object motions based on the first intermediate denoised motion;
generating one or more second noisy latent distributions based on combining the one or more updated articulated object motions with the noise signal;
sampling the one or more second noisy latent distributions to generate one or more second latent motions from the plurality of latent motions; and
processing the one or more second latent motions according to one or more second control signals, from the plurality of control signals, to produce one or more second intermediate denoised motions, wherein the one or more second control signals are based on the one or more updated articulated object motions.

7. The computer-implemented method of claim 1, wherein determining the global camera motion and the global articulated object motion comprises:
determining known articulated object motions of the input video based on the initial articulated object motion;
determining unknown articulated object motions of the input video based on the plurality of intermediate denoised motions generated using the controlled motion denoiser;
determining a Control-Inpainting Score Distillation Sampling (COIN-SDS) loss based on the known articulated object motions and the unknown articulated object motions; and
determining the global camera motion and the global articulated object motion based on the COIN-SDS loss.

8. The computer-implemented method of claim 7, wherein determining the COIN-SDS loss comprises:
generating one or more inpainted motions based on the known articulated object motions, the unknown articulated object motions, and a continuous mask, wherein the continuous mask is associated with a denoising step and a confidence score of the observations; and
determining the COIN-SDS loss based on the one or more inpainted motions.

9. The computer-implemented method of claim 8, wherein generating one or more inpainted motions comprises generating a plurality of inpainted motions, wherein each of the plurality of inpainted motions is associated with a different denoising step of a plurality of denoising steps, and wherein a final inpainted motion, from the plurality of inpainted motions, is used to determine the COIN-SDS loss.

10. The computer-implemented method of claim 1, wherein determining the global camera motion and the global articulated object motion comprises:
determining a Control-Inpainting Score Distillation Sampling (COIN-SDS) loss based on using the controlled motion denoiser and the plurality of intermediate denoised motions;
determining a human-scene relation loss based on a point cloud associated with the initial camera motion; and
determining the global camera motion and the global articulated object motion using the COIN-SDS loss and the human-scene relation loss.

11. The computer-implemented method of claim 10, wherein determining the global camera motion and the global articulated object motion is further based on a body loss that is determined based on the initial camera motion and/or the initial articulated object motion, wherein the body loss comprises a re-projection loss.

12. The computer-implemented method of claim 1, wherein outputting the global camera motion and the global articulated object motion comprises:
using the global camera motion and the global articulated object motion to control one or more robotic systems.

13. The computer-implemented method of claim 1, wherein at least one of the steps of obtaining, generating, determining, and outputting are performed on a server or in a data center to determine the global camera motion and the global articulated object motion, and the global camera motion and the global articulated object motion are streamed to a user device.

14. The computer-implemented method of claim 1, wherein at least one of the steps of obtaining, generating, determining, and outputting are performed within a cloud computing environment.

15. The computer-implemented method of claim 1, wherein at least one of the steps of obtaining, generating, determining, and outputting are performed for training, testing, or certifying a neural network employed in a machine, robot, or autonomous vehicle.

16. The computer-implemented method of claim 1, wherein at least one of the steps of obtaining, generating, determining, and outputting is performed on a virtual machine comprising a portion of a graphics processing unit.

17. A system, comprising:
one or more processors; and
a non-transitory computer-readable medium having processor-executable instructions stored thereon, wherein the processor-executable instructions, when executed by the one or more processors, facilitate:
determining an initial articulated object motion of an articulated object based on an input video comprising a plurality of frames that depict motion of the articulated object, wherein the input video is obtained by a non-stationary camera, wherein the initial articulated object motion is in a local coordinate system associated with the non-stationary camera;
determining, based on the input video, the initial camera motion in a global coordinate system that is a real-world coordinate system;
generating a plurality of intermediate denoised motions based on inputting a plurality of control signals and a plurality of latent motions associated with the initial articulated object motion into a controlled motion denoiser comprising a control branch and a motion diffusion model, wherein the plurality of control signals are input into the control branch to control the motion diffusion model and the plurality of latent motions are input into the motion diffusion model to generate the plurality of intermediate denoised motions;
determining the global camera motion and the global articulated object motion based on the plurality of intermediate denoised motions, wherein the global camera motion and the global articulated object motion are both in the global coordinate system; and
outputting the global camera motion and the global articulated object motion.

18. The system of claim 17, wherein the processor-executable instructions, when executed by the one or more processors, facilitate:
converting the initial articulated object motion from the local coordinate system to the global coordinate system, and
wherein determining the global articulated object motion based on the plurality of intermediate denoised motions comprises refining the initial articulated object motion that has been converted to the global coordinate system using the plurality of intermediate denoised motions.

19. The system of claim 17, wherein determining the initial camera motion is based on using a Simultaneous Localization and Mapping (SLAM) algorithm, and wherein determining the initial articulated object motion is based on using a 3-dimensional (3-D) Pose Estimator.

20. A non-transitory computer-readable medium having processor-executable instructions stored thereon, wherein the processor-executable instructions, when executed, facilitate:
determining an initial articulated object motion of an articulated object based on an input video comprising a plurality of frames that depict motion of the articulated object, wherein the input video is obtained by a non-stationary camera, wherein the initial articulated object motion is in a local coordinate system associated with the non-stationary camera;
determining, based on the input video, the initial camera motion in a global coordinate system that is a real-world coordinate system;
generating a plurality of intermediate denoised motions based on inputting a plurality of control signals and a plurality of latent motions associated with the initial articulated object motion into a controlled motion denoiser comprising a control branch and a motion diffusion model, wherein the plurality of control signals are input into the control branch to control the motion diffusion model and the plurality of latent motions are input into the motion diffusion model to generate the plurality of intermediate denoised motions;
determining the global camera motion and the global articulated object motion based on the plurality of intermediate denoised motions, wherein the global camera motion and the global articulated object motion are both in the global coordinate system; and
outputting the global camera motion and the global articulated object motion.
